(19) United States
(12) Patent Application Publication
(10) Pub. No.: US 2025/0292110 A1
(43) Pub. Date: Sep. 18, 2025

(54) ENHANCED QUERY PROCESSING USING DOMAIN SPECIFIC RETRIEVAL-AUGMENTED GENERATION FOR FINANCIAL SERVICES

(71) Applicant: Auquan Ltd., London (GB)

(72) Inventors: Chandini Jain, London (GB); Shubham Jain, Bangaluru (IN)

(21) Appl. No.: 19/080,629

(22) Filed: Mar. 14, 2025

Related U.S. Application Data
(60) Provisional application No. 63/566,177, filed on Mar. 15, 2024.

(51) Int. Cl. G06N 5/02; G06Q 40/06

(52) U.S. Cl. CPC G06N 5/02; G06Q 40/06

(57) ABSTRACT

Embodiments of the present invention provide an innovative Retrieval-Augmented Generation (RAG) system tailored for financial analysis, significantly enhancing the precision and contextual relevance of Large Language Models (LLMs). A part of the system is a query augmentation component that leverages a knowledge graph to semantically enrich user queries, ensuring comprehensive retrieval of pertinent financial documents. A noise filtering mechanism refines the search results, while a relevance ranking component prioritizes documents based on context (e.g., user and task). The system employs prompt engineering to guide the LLM in generating responses that meet the specific requirements of financial analysis. Additionally, the LLM is fine-tuned using a corpus of financial questions and answers, reinforced by human-in-the-loop feedback, to adapt the model to the financial domain's unique linguistic and structural nuances. This advanced RAG system offers financial professionals timely, reliable, and actionable insights, providing a competitive edge in a rapidly evolving financial landscape.

### RELATED APPLICATIONS

This application claims priority to U.S. Provisional Patent Application No. 63/566,177, entitled “ENHANCED QUERY PROCESSING USING RETRIEVAL-AUGMENTED GENERATION FOR FINANCIAL DATA ANALYSIS,” filed on Mar. 15, 2024, which is hereby incorporated by reference in its entirety.

### TECHNICAL FIELD

The present disclosure relates to the technical field of information retrieval and natural language processing, including techniques for augmenting query understanding and response generation. More specifically, the present disclosure relates to techniques for implementing Retrieval-Augmented Generation (RAG) that enhance the capabilities of generative language models, such as Large Language Models (LLMs), in financial analysis applications by leveraging structured knowledge graphs and user-contextual data to provide accurate, relevant, and up-to-date information in response to financial queries.

### BACKGROUND

In the realm of computational finance, the ability to quickly and accurately process vast amounts of data to extract relevant information is paramount. Financial analysts, compliance officers, risk managers, and other professionals in the financial sector rely heavily on sophisticated software-based tools to sift through extensive databases, including earnings reports, regulatory filings, and market news, to inform their decisions. The advent of natural language processing (NLP) and information retrieval systems has significantly advanced the efficiency with which financial data can be analyzed, enabling the extraction of insights from unstructured text and the summarization of complex information into actionable intelligence.

Generative language models, for example, such as Large Language Models (LLMs) like those built based on the Transformer architecture, have shown impressive proficiency in generating human-like text and processing natural language queries. Trained on vast, diverse datasets, they can execute a range of tasks without needing further task-specific training. Yet, their reliance on static datasets at the time of their last training update poses a significant limitation. In the fast-paced financial sector, where market conditions and regulations change rapidly. LLMs' static knowledge quickly becomes obsolete, leaving them unable to provide current information or insights into recent events. This limitation is compounded when addressing long-tail queries or highly specialized topics, as these scenarios often lack sufficient representation in the training data. The inability of LLMs to integrate real-time updates critically undermines their effectiveness for financial analysis, where the most recent data is crucial, and the cost of decisions based on outdated or incomplete information can be substantial.

Another significant limitation of LLMs is their lack of transparency, which poses a challenge in trust and reliability for users in the financial sector. When LLMs generate content, they do not typically provide citations or reveal the sources of their information, making it difficult for users to verify the accuracy and bias of the generated output. This “black box” nature of LLMs can lead to skepticism among financial professionals who require a clear audit trail for compliance and due diligence purposes. Without the ability to trace the origin of the information or understand the reasoning behind the model's outputs, there is a risk of basing critical financial decisions on unverified or biased data. In an industry where transparency is not just valued but mandated by regulatory standards, the opaqueness of LLMs presents a significant barrier to their adoption and utility in financial applications.

### BRIEF DESCRIPTION OF THE DRAWINGS

Embodiments of the present invention are illustrated by way of example and not limitation in the figures of the accompanying drawings, in which:

FIG. 1 is a diagram illustrating an example of a conventional search system deploying Retrieval-Augmented Generation (RAG) with a Large Language Model (LLM).

FIG. 2 is a diagram illustrating an improved RAG-based query processing system for processing financial queries, consistent with some examples.

FIG. 3 is a diagram illustrating an example of a knowledge graph that is leveraged to expand a user query, consistent with some examples.

FIG. 4 is a block diagram illustrating a software architecture, which can be installed on any of a variety of computing devices to perform methods consistent with those described herein.

FIG. 5 illustrates a diagrammatic representation of a machine in the form of a computer system (e.g., a server computer) within which a set of instructions may be executed for causing the machine to perform any one or more of the methodologies discussed herein, according to an example embodiment.

### DETAILED DESCRIPTION

Described herein are techniques for enhancing the performance of Retrieval-Augmented Generation (RAG) systems for financial analysis tools. More precisely, embodiments of the invention include methods and systems for augmenting user queries with domain-specific knowledge graphs, filtering out irrelevant information through noise reduction algorithms, and dynamically ranking documents based on user context and intent. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

Large Language Models (LLMs) like the series of Generative Pre-trained Transformer (GPT) models developed by OpenAI® are powerful tools capable of generating human-like text, making these tools revolutionary in various applications of natural language processing. However, despite their impressive linguistic abilities, LLMs are not inherently well-suited for financial analysis. This is primarily because they rely on static datasets from their training period and lack the ability to incorporate real-time, domain-specific financial data. Consequently, they may produce outdated or generalized information, which is a significant drawback in the rapidly changing financial sector where current, specialized knowledge is crucial for accurate analysis and decision-making.

Retrieval-Augmented Generation (RAG) has emerged as a solution to the limitations of LLMs in financial services. RAG enhances the generative capabilities of LLMs by integrating LLMs with a retrieval component that can access and incorporate up-to-date, relevant financial data from a variety of sources. This approach allows RAG-based systems to provide responses that are not only linguistically coherent but also factually accurate and tailored to the specific context of financial queries. By bridging the gap between the vast knowledge base of LLMs and the dynamic nature of financial information, RAG-based systems offer a more reliable and efficient tool for financial analysis, ensuring that the insights generated are both timely and pertinent to the user's needs.

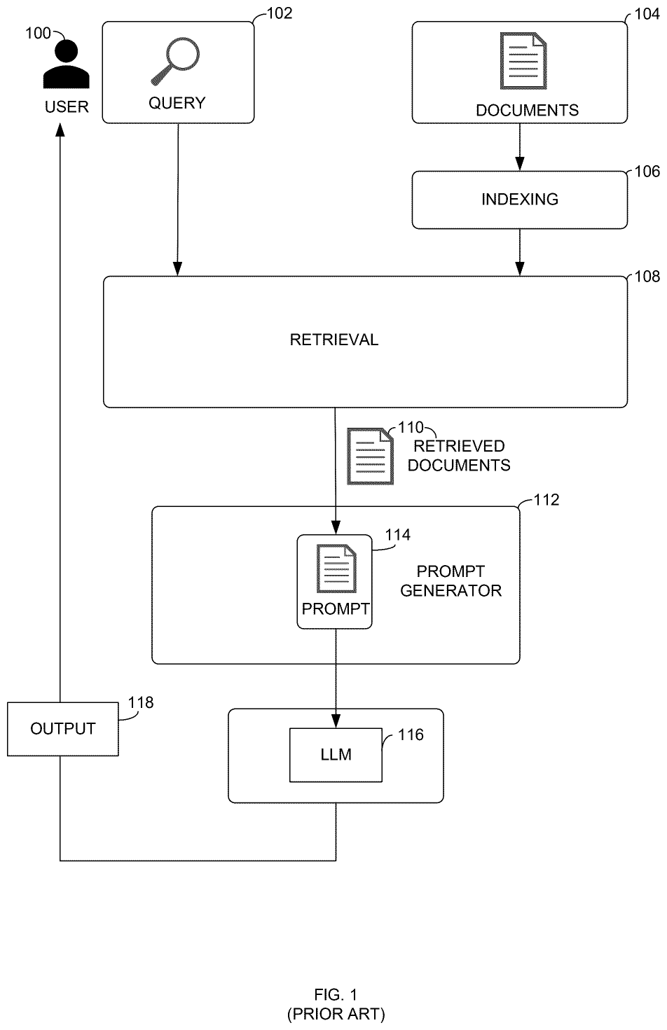

In FIG. 1, a flow diagram for a conventional RAG-based system is depicted, illustrating the foundational workflow of integrating a retrieval process with a generative language model to enhance the response generation for user queries. The technique begins with a user 100 inputting a query 102. The query 102 is typically a text string that encapsulates the user's information need, such as a question about a financial entity or a request for analysis on a market trend. Prior to the user submitting the query, a preparatory step is undertaken where documents 104 are analyzed and organized into a searchable index 106. This pre-processing phase improves the system's efficiency, as it transforms raw data into a structured format that is primed for search and retrieval. In some instances, documents may be indexed by keywords, facilitating a search based on specific terms within the user's query. However, other, more advanced implementations employ a vectorization process, where documents or significant portions thereof are converted into one or more embeddings. These embeddings serve as numerical representations that encapsulate the essence of the document's content, themes, and context in a multi-dimensional vector space. This method of indexing by vectorization allows for a more sophisticated retrieval based on semantic similarity, enabling the system to recognize and retrieve documents that are contextually relevant to the user's query, even when explicit keywords may not be present.

Upon receiving the query 102, the retrieval system 108 interacts with the pre-constructed index of documents. The documents represented within this index can range from financial reports and market analyses to regulatory filings and news articles, each potentially holding valuable insights pertinent to the user's query. The indexing process is a step that determines the ease and speed with which relevant documents can be retrieved.

During the retrieval step, documents that are most relevant to the user's query are identified. This may be achieved by matching the content of the documents against the query, often using keyword matching or other similarity measures. For example, in the case where content has been vectorized, various measures of distance between a query vector and a content vector can be used to select content. The outcome of this step is a subset of documents 110 from the index that the system deems relevant to the query.

The final step in the conventional RAG-based system involves the generation of a response by the LLM 116. A prompt generator 112 generates a prompt, which includes the selected documents and typically the user's original query. This enriched prompt is then provided as input to the LLM 116, which generates a textual response as output 118. The LLM 116 leverages its pre-trained knowledge and the provided context in the prompt to produce an answer that aims to be both coherent and informative. The quality of the generated output is heavily reliant on the relevance of the documents retrieved and the LLM's ability to synthesize the information accurately. The output 118 is then presented to the user, completing the RAG-based system's cycle from query 102 to response (e.g., output 118).

In a conventional RAG-based search system such as that illustrated in FIG. 1, a first significant challenge arises when users input queries that are inherently narrow or ambiguous, leading to a retrieval of documents that may not fully capture the breadth or depth of information required for comprehensive financial analysis. For instance, a conventional RAG system might interpret a query such as “risk assessment for Tesla” strictly within the narrow confines of the query's text, overlooking broader but highly relevant concepts like market trends, regulatory changes, or supply chain vulnerabilities that impact Tesla's risk profile.

Consistent with some embodiments of the present invention, query augmentation is leveraged to address this issue by expanding the scope of the query to include a wider array of related terms and concepts, effectively constructing a more detailed semantic map of the user's informational needs. In the financial domain, this means that a query about “Tesla's market risks” is enriched to consider associated factors such as “electric vehicle legislation,” “battery supply chain disruptions,” or “emerging competitors in the EV space.” By doing so, query augmentation ensures that the search system retrieves a more comprehensive set of documents, leading to richer insights and more informed decision-making for financial professionals.

In certain embodiments of the present invention, the process of query augmentation is achieved through the generation of a “query ecosystem” using a knowledge graph. This knowledge graph is structured with nodes that in some instances correlate with various search indices, which may correspond to different facets of the financial domain, such as market sectors, key personnel, product lines, and raw materials, or different sources of data. In other instances, the knowledge graph may be integrated with a corresponding graph database, wherein the nodes of the knowledge graph are aligned with the nodes of the graph database, thereby streamlining the retrieval process. When a user inputs a query like “risk assessment for Tesla,” the system activates the knowledge graph to identify and link related nodes, thereby creating an “ecosystem” that encapsulates Tesla's broader market and operational context. This ecosystem might include nodes for electric vehicle regulations, lithium battery suppliers, and competitive market analysis, among others. The connections between the nodes are then utilized to identify other topics, concepts, data sources, and so forth, to enrich the original query, transforming it into a multi-dimensional search directive that captures a spectrum of related concepts. As a result, the retrieval process is not just limited to direct keyword or semantic concept matches but is extended to include and retrieve documents that are contextually relevant to the augmented or expanded query, ensuring that financial analysts are provided with a holistic view of the subject matter for their analysis.

Within the typical or conventional framework of a RAG-based search system, a second technical problem arises as a result of the retrieval process often yielding a plethora of documents, among which only a subset is truly relevant to the user's query, while the rest may constitute “noise”—irrelevant or low-quality information that can obscure critical insights. For example, a financial analyst seeking information on “Tesla's quarterly financial growth” might be inundated with documents that mention Tesla in various unrelated contexts, such as technology innovation or leadership changes, which do not pertain to financial performance.

Consistent with some embodiments of the present invention, a noise filtering technique serves as a refinement step, sifting through the initial broad set of retrieved documents to discard those that do not align with the financial context of the query. By employing sophisticated vector comparisons and machine learning classification, noise filtering hones in on documents that specifically address financial data, risk assessments, and market analyses relevant to Tesla's financial growth, and relevant to the context in which the user is performing the search—for example, user and task-related contextual information. This targeted filtering not only streamlines the information retrieval process but also ensures that the data used for generating responses is of high relevance and quality, thereby enhancing the precision and utility of the RAG system for financial professionals.

Consistent with some embodiments, in the noise filtering step, one or more pre-trained machine learning models, which have undergone supervised training to classify the content accurately, are used to pre-process the documents that are searchable. These pre-trained machine learnings models have been individually trained on a diverse set of labeled data, where each document is tagged with metadata that represents its content, such as topics, entities, sentiment, and relevance to specific domains like finance, technology, or legal matters. These pre-trained classifiers are then used to generate metadata for the searchable documents, and to assess each document's alignment with the user's query context. For instance, a document might be classified under ‘financial risk analysis’ or ‘market trend predictions,’ enabling the system to filter out documents that fall under unrelated categories such as ‘corporate social events’ or ‘product launches.’ The noise filtering mechanism applies these classifications by selectively including or excluding documents based on their metadata tags, which have been pre-generated using the pre-trained machine learning models. This ensures that only the documents with metadata indicating high relevance to the financial query's context are presented in the search results, thereby enhancing the precision of the information retrieval and significantly reducing the volume of non-essential data that would otherwise dilute the quality of the response generated by the LLM of the RAG system.

Finally, in a conventional RAG-based search system, the retrieval process may filter out irrelevant noise but still struggle to prioritize the relevance of the remaining set of initially retrieved documents in relation to the user's specific inquiry. This can result in a homogeneous set of documents being provided as input to the LLM, such that the output of the LLM may not reflect the nuanced priorities of the user's role or the requirements of the specific task being performed. For example, a compliance officer seeking information on “regulatory compliance of Tesla” would benefit from immediate access to the most critical legal documents rather than a generic mix of compliance-related content.

Consistent with some embodiments of the present invention, the subset of documents remaining after the noise filtering step has been applied are further subjected to a relevance ranking step. Relevance ranking mitigates the aforementioned issue by intelligently ranking, organizing, and in some instances, eliminating some of the documents before they are presented to the LLM, ensuring that the most pertinent information is considered in the generation of the final output. This may be accomplished through machine learning models that have been trained to discern patterns in user interactions and document relevance, thus enabling the RAG system to provide financial professionals with targeted information that aligns with their immediate needs and supports expedited and more accurate decision-making.

Other aspects and advantages of embodiments of the invention will be apparent from the detailed description of the several figures that follows.

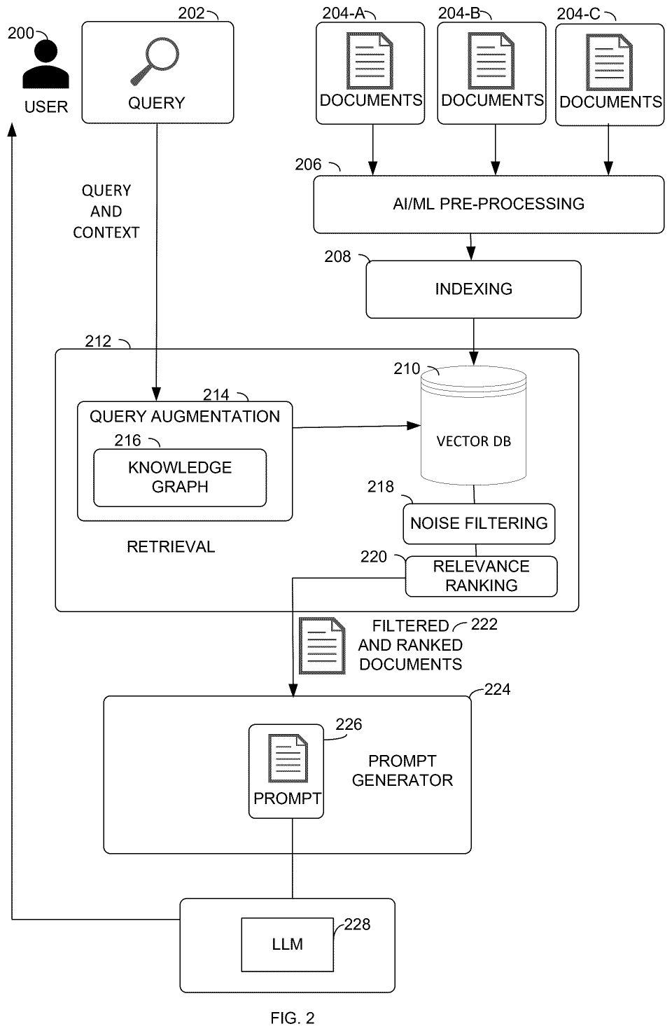

FIG. 2 is a diagram illustrating an improved RAG-based query processing system for processing financial queries, consistent with some examples. The system depicted in FIG. 2 enhances the conventional RAG framework by incorporating components that refine the retrieval and generation processes, thereby addressing the challenges identified in conventional RAG systems. First, a query augmentation component 214 employs a knowledge graph 216 to enrich user queries 202, broadening the semantic scope of a user query to capture a more comprehensive range of related concepts. A noise filtering component 218 then refines the retrieval output, utilizing contextual details about the user and task to sift through and eliminate non-relevant content. Subsequently, a relevance ranking component 220 prioritizes the remaining content based on its contextual significance, aligning with the user's specific informational needs. The prompt generator 224 integrates this contextually rich information with the user's query to dynamically tailor prompts, optimizing the LLM's 228 response generation. Lastly, the LLM 228 itself is fine-tuned for financial analysis, ensuring that the generated responses are not only linguistically coherent but also adhere to the domain-specific requirements of financial data analysis. FIG. 2 will be expounded upon to demonstrate how each component contributes to a more precise, user-centric, and context-aware financial query processing system.

Consistent with some examples, the system's document ingestion flow, as depicted in FIG. 2, is designed to integrate and process content from a multitude of data sources, such as financial reports, market analyses, regulatory filings, and news articles, represented by documents 204-A, 204-B, and 204-C. This integration facilitates the ingestion of content in near real-time, ensuring that the most current and relevant financial data is available for retrieval and analysis.

Upon acquisition, documents undergo pre-processing analysis conducted by one or more pre-trained machine learning models 206. These models are adept at performing entity recognition, topic classification, and sentiment analysis, among other tasks. Accordingly, as each document is ingested, valuable metadata for the document is generated using the various pre-trained machine learning models. For instance, a document containing an earnings report may be analyzed to identify key financial entities such as revenue figures, market trends, and executive statements. The models are trained on a diverse set of labeled financial data, enabling them to discern and tag metadata that accurately represents the content's nature and relevance to specific financial domains.

Subsequent to the pre-processing analysis, the documents are encoded into embeddings and then indexed in some manner. This encoding process involves breaking down the text into manageable chunks and transforming these chunks into vector representations using an embedding model. The embeddings capture the semantic nuances of the text, allowing for a more nuanced retrieval based on semantic similarity rather than mere keyword matching. For example, a chunk of text discussing ‘quarterly revenue growth’ would be encoded in such a way that its embedding reflects this specific financial concept, enabling the retrieval system to recognize and retrieve documents that discuss similar financial growth metrics.

The result of this encoding process is a database where documents are indexed in several ways, including by keywords, entities, topics, and so forth. This multi-faceted indexing approach allows for a robust and flexible retrieval system capable of handling complex financial queries. For example, a query for ‘market volatility’ could retrieve documents not only containing the exact phrase but also those discussing related concepts such as ‘economic uncertainty’ or ‘fluctuating stock prices,’ thanks to the semantic understanding imbued by the embeddings.

Consistent with some embodiments, the dual approach of utilizing both embeddings and metadata for indexing and retrieval offers a significant advantage in the RAG system. While embeddings allow for matching a query to content based on semantic similarity, metadata produced by machine learning models enables a more precise analysis and retrieval of content. This hybrid method ensures that the retrieval process is both comprehensive and accurate.

For instance, when a user submits a query related to ‘interest rate hikes.’ the system may first use embeddings to find documents that are semantically related to the concept of interest rates changing. The embeddings ensure that the retrieval is not limited to documents that contain the exact phrase but also includes content that discusses related ideas such as ‘central bank policy adjustments’ or ‘inflation control measures.’ This semantic matching allows for capturing the essence of the user's informational needs and providing a broad set of relevant documents.

Concurrently, the system leverages metadata for a more granular analysis. Documents in the system may be indexed with metadata tags that classify them according to specific financial topics, entities involved, sentiment, and other relevant attributes identified by the machine learning models. This metadata allows for precision querying within the semantically similar set of documents. For example, if the user is specifically interested in how ‘interest rate hikes’ affect the ‘housing market,’ the system can narrow down the search to documents tagged with metadata related to ‘real estate’ or ‘mortgage rates,’ thereby providing a more targeted subset of documents.

This combined approach ensures that the retrieval system can cater to complex financial queries with high precision. Users benefit from a retrieval process that not only understands the broader context of their search but also pinpoints the exact information they require. This is particularly advantageous in the financial domain, where the accuracy and specificity of information can have significant implications for decision-making and strategy development.

An alternative technique employed by the system may involve the use of a graph database. In this approach, a knowledge graph is not just a static entity but is dynamically linked to a graph database where nodes represent documents or significant portions thereof. The edges in the graph database denote semantic or contextual relationships between documents, such as shared topics or referenced entities. This graph-based indexing allows for multi-dimensional retrieval capabilities. For instance, a search for ‘interest rate effects’ could traverse the graph to find documents related to ‘central bank policies,’ ‘bond yield impacts,’ or ‘mortgage market reactions,’ providing a comprehensive view of the interest rate's influence across various financial sectors. Through these advanced document ingestion and indexing techniques, the system ensures that financial professionals have access to a rich, well-organized, and easily retrievable knowledge base, facilitating informed decision-making and insightful financial analysis.

When a user 200 initiates a query 202 within the system, a multifaceted process is triggered to ensure that the most relevant and contextually appropriate information is retrieved by the retrieval component 212. The user's query 202, along with additional contextual information, is passed to the retrieval component 212. This context data is comprehensive, potentially including the user's role, such as their title or position within their organization, historical searches performed by the user, and other pertinent data relating to the user's search behavior and preferences. In some instances, the context may also be determined by the user interface from which a query was initiated and received. For example, a client application may provide a user interface with various modules or sections from which a query can be initiated, such as a dashboard for compliance-related queries or a market analysis portal. This interface context can provide valuable clues about the task the user is attempting to perform, further informing the retrieval process.

The query and the context are then utilized by the query augmentation component 214 to expand and enhance the original query. This component analyzes the query to determine keywords, topics, and other relevant terms. Leveraging a knowledge graph, the query augmentation component creates a query “ecosystem” that encompasses a wider array of related concepts and entities. For instance, if the query is “Tesla's financial outlook,” the query augmentation component 214 may recognize the named entity, “Tesla”, and then create via the knowledge graph a query ecosystem that include nodes for electric vehicle market trends, Tesla's recent financial statements, and key industry events that could impact Tesla's economic position.

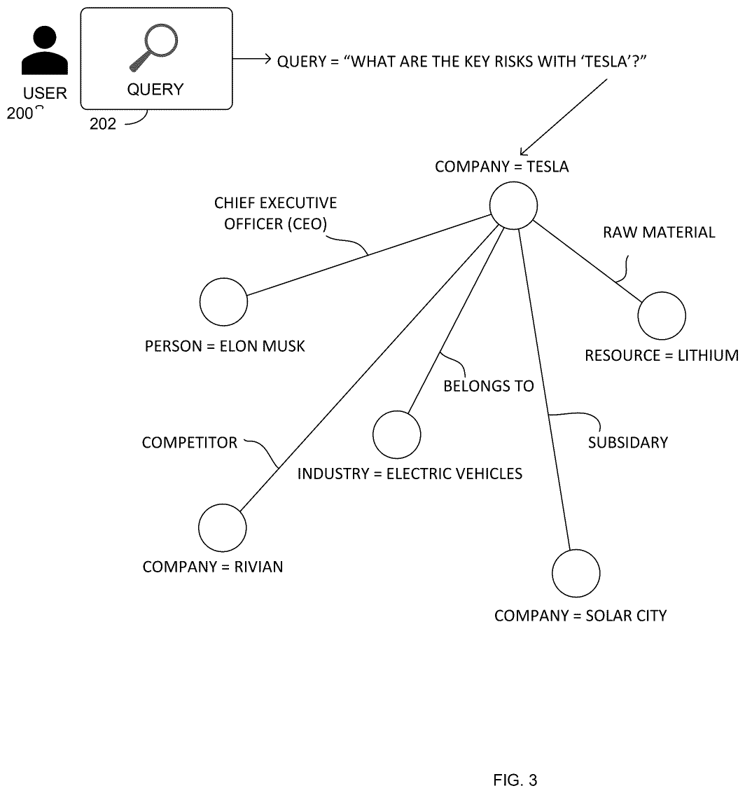

FIG. 3 provides a visual representation of a knowledge graph that may be leveraged by the query augmentation process facilitated by the query augmentation component 214, a feature of the RAG-based query processing system. FIG. 3 illustrates how a user's query 202, such as “what are the key risks with Tesla,” is expanded or enhanced using a knowledge graph 216. In this knowledge graph, each node represents an entity relevant to the financial domain, and the edges connecting these nodes signify the relationships between these entities.

For example, in the context of the query “what are the key risks with Tesla.” the knowledge graph 216 might include nodes for ‘company=Tesla as the primary entity, ‘Person=Elon Musk’ as a key individual associated with Tesla. ‘Industry=electric vehicles’ as the industry sector, ‘Company=Rivian’ as a competitor, ‘Resource=lithium’ as a raw material critical to Tesla's products, and ‘company=Solar City’ as a subsidiary. The edges between these nodes represent the relationships, such as Tesla's CEO being Elon Musk, Tesla's industry being electric vehicles, and so forth.

The query augmentation component 214 uses the query 202 and additional context—such as the user's role and the task at hand—to select a subset of nodes and relationships from the knowledge graph 216, thereby identifying an “ecosystem” for the query. This ecosystem provides a multi-dimensional perspective on the query, extending beyond the initial search term to encompass related concepts and entities that could influence the financial risks associated with Tesla.

This query ecosystem is then leveraged to generate one or, in some cases, multiple expanded queries that are used to identify relevant content within the system's indexed database. For instance, the expanded queries might include “Tesla's market trends,” “Elon Musk's impact on Tesla's stock,” “electric vehicle legislation,” “Rivian's competitive strategies,” “lithium supply chain risks,” and “Solar City's financial health.”

In some instances, the nodes within the knowledge graph may correspond with specific indexes in the database, allowing for targeted retrieval of documents related to those nodes. In other instances, the knowledge graph may be integrated with a corresponding graph database, where the relationships between nodes can be used to perform complex queries that traverse the graph to find documents that cover multiple related topics or concepts.

By utilizing a knowledge graph in this manner, the system ensures that the retrieval process is not only based on the literal text of the user's query but also on a broader understanding of the financial landscape surrounding Tesla. This results in a more comprehensive and nuanced retrieval of documents, providing financial professionals with a holistic view of the risks and opportunities associated with Tesla, and enabling them to make well-informed decisions based on a rich array of interconnected financial data.

Referring again to FIG. 2, the enriched query is then encoded as one or more embeddings. These embeddings are crafted to represent the query's expanded semantic scope, capturing the essence of the user's informational needs in a form that is amenable to vector-based retrieval. The system employs a vector-to-vector comparison to identify relevant content, where a similarity measure based on the distance between vectors is used to determine relevance. Several distance measures might be employed, including cosine similarity, which measures the cosine of the angle between two vectors; Euclidean distance, which calculates the straight-line distance between two points in vector space; and Manhattan distance, which sums the absolute differences of their coordinates. By utilizing these measures, the system can effectively identify documents whose embeddings are closest to the query embedding, indicating a high degree of relevance to the user's query.

Through this process, the system ensures that the retrieval component is not merely responding to the literal text of the user's query but is engaging in a deeper, more nuanced search that accounts for the broader context of the user's needs. This approach enables the system to provide financial professionals with targeted, high-quality information that supports their specific analytical tasks and decision-making processes.

The initial set of retrieved documents, which may include a wide array of financial data such as market reports, legal documents, and company filings, is subjected to a refinement process by the noise filtering component 218. This component is integral to the system's ability to deliver precise and relevant information to the user. It receives as input the contextual data that accompanied the query, which includes insights into the user's role, historical search patterns, and the specific task they aim to accomplish.

Utilizing this rich contextual data, the noise filtering component 218 applies sophisticated algorithms to sift through the retrieved documents. Its primary function is to exclude content that does not align with the user's current needs and the task at hand. For example, if the user is a compliance officer investigating regulatory risks associated with a company, the noise filtering component will prioritize documents related to legal issues and sanctions while filtering out unrelated content such as general news articles or product announcements. The filtering may be accomplished by leveraging the metadata that is produced during the pre-processing analyses performed by the various machine learning models 206.

In addition to content relevance, the noise filtering component 218 may also performs deduplication and diversification processes. Deduplication involves identifying and removing duplicate information that may be present across multiple documents, ensuring that the LLM, and ultimately the user, is not presented with redundant data. Diversification, on the other hand, aims to present a broad spectrum of unique and relevant content. This is achieved by analyzing the thematic and topical variety within the retrieved documents and ensuring that a wide range of perspectives and information is included in the final set presented to the LLM, and ultimately to the user.

The deduplication process might involve comparing document embeddings to detect overlapping content, while diversification may require clustering techniques to group similar documents and then selecting representative samples from each cluster. For instance, in the context of financial data, deduplication ensures that the same financial statement reported in multiple news outlets is only presented once, while diversification ensures that the final set includes varied reports covering different aspects of a company's financial health, such as liquidity, debt levels, and revenue streams.

The advantages of this noise filtering process are manifold. It enhances the efficiency of the system by reducing the volume of data that needs to be processed in subsequent stages, thereby speeding up the response time. It also improves the quality of the information presented to the user, ensuring that the data is not only relevant but also diverse and comprehensive, providing a well-rounded view of the financial topic in question. This filtering process is beneficial for financial professionals who rely on timely and accurate data to make informed decisions in a fast-paced and often volatile financial environment.

Relevance ranking 220 is the final refinement step in the RAG system's retrieval process, where the documents that have passed through the noise filtering stage are organized in order of their importance to the user's query. This step involves tailoring the response to the specific needs of the user, taking into account their role, workflow, the task at hand, and the expected outcome of their query. The relevance ranking process employs advanced machine learning algorithms that have been trained to discern the varying importance of documents based on user-specific criteria.

The system begins by constructing a user profile that captures the user's role within the financial sector, such as an equity research analyst, a compliance officer, or a sustainability analyst. This profile includes information about the types of documents and information that are typically most relevant to the user's tasks. For instance, a compliance officer may frequently require legal documents, regulatory filings, and information on sanctions, while an equity research analyst may prioritize earnings reports, market analyses, and broker research.

Once the user profile is established, the system applies a ranking algorithm to the filtered set of documents, based on the user profile. This algorithm considers both the semantic content of the documents and the user profile to assign a relevance score to each document. Documents that are more closely aligned with the user's information needs receive a higher score and are placed higher in the ranked list. The algorithm is dynamic and can adjust the relevance scores as it learns from the user's interactions with the system, such as which documents they find most useful or which they disregard.

For example, if a user queries about “emerging risks in the fintech industry,” the relevance ranking process would work as follows: After the noise filtering step, the system would have a set of documents related to various aspects of the fintech industry. If the user is a risk manager, the ranking algorithm would prioritize documents discussing regulatory challenges, cybersecurity threats, and competitive pressures over those focusing on technological innovations or startup culture within the fintech space. The ranked list would then present the risk manager with documents that are most likely to contain the insights needed to assess and manage risks in the fintech industry.

The relevance ranking process is a blend of user-centric customization and semantic understanding, ensuring that the RAG system delivers information that is not only accurate and up-to-date but also highly personalized to the user's specific context. This approach significantly enhances the efficiency of the retrieval process and ensures that the LLM generates responses that are directly relevant to the user's immediate needs, thereby solving one of the key technical challenges in the field of financial data analysis and decision-making.

The prompt generator 224 serves as an intermediary between the retrieval process and the response generation by the LLM 228. Upon receiving the ranked and filtered documents, the prompt generator 224 synthesizes these documents—specifically, the text of the documents—with the user's query 202 and additional contextual information to construct a comprehensive and contextually rich prompt. This prompt 226 serves as the input for the LLM, guiding it to generate a response that is not only linguistically coherent but also factually accurate and tailored to the user's informational needs.

The prompt generator 226 begins by incorporating an instruction portion derived from the user's query and the context in which the search is performed. This instruction portion is crafted to reflect the user's intent and the specific outcome they seek from the query. It provides the LLM 228 with a clear directive on the nature of the response required, whether it be a summary, an analysis, or a direct answer to a question.

Following the instruction portion, the prompt generator 224 includes the text from the filtered and ranked documents. The text is carefully ordered based on the relevance ranking of the documents, ensuring that the most pertinent information is presented prominently. This ordering may influence the LLM's focus during the generation process, directing it to prioritize information from the highest-ranked documents.

For example, in the context of financial analysis, consider a user who is an equity research analyst querying about “emerging risks in the fintech industry.” The prompt generator 224 would first formulate an instruction portion such as “Provide an analysis of the emerging risks in the fintech industry based on the following information.” It would then append text excerpts from the top-ranked documents, which might include recent regulatory changes, market volatility reports, and competitive landscape analyses. These excerpts would be arranged in a sequence that mirrors their relevance to the query, with the most critical insights placed at the forefront of the prompt.

Here is an illustrative example of how a prompt 226 might be structured for a financial analysis query:
Instruction: Analyze the current financial risks associated with the fintech industry, focusing on market trends, regulatory impacts, and technological advancements. Based on the selected documents, provide a comprehensive overview that addresses the following points:
Market Volatility: Examine the implications of recent fluctuations in the stock market on fintech companies, highlighting any potential risks to their financial stability.
Regulatory Environment: Discuss the impact of new regulations introduced in the fintech sector and how they might pose risks to business operations and growth.
Technological Disruptions: Assess the risks posed by emerging technologies that could disrupt existing business models within the fintech industry.

### Document Excerpts:

[Excerpt from Document A, the highest-ranked document, discussing market volatility]
[Excerpt from Document B, detailing recent regulatory changes]
[Excerpt from Document C, analyzing potential technological disruptions]’

The prompt generator's ability to integrate the user's query, the context of the search, and the content of the retrieved documents into a coherent prompt 226 is instrumental in leveraging the full capabilities of the LLM 228 for financial analysis applications. This integration ensures that the insights generated by the LLM 228 are both timely and pertinent to the user's specific informational needs.

Consistent with some embodiments, the LLM 228 may be fine-tuned for performing the various types of financial analysis described herein. Fine-tuning a LLM for financial analysis involves adapting the model to understand and generate responses that are specific to the financial domain. This process enhances the LLM's ability to interpret financial documents, answer related queries accurately, and produce outputs that adhere to the stylistic and structural nuances of financial discourse. The fine-tuning process can be broken down into several key steps.

Consistent with some embodiments, the fine-tuning process may begin with the creation of a specialized corpus consisting of financial questions and their corresponding answers. This corpus is curated to cover a wide range of financial topics, including market trends, regulatory changes, risk assessments, and economic indicators. The questions are designed to mimic the types of inquiries a financial analyst might pose, while the answers provide model responses that are accurate, informative, and formatted in a manner consistent with financial reporting and analysis.

Consistent with some embodiments, to further refine the LLM's performance, reinforcement learning (RL) with a human in the loop is employed. This approach involves an iterative process where the LLM generates responses to financial queries, and human experts review and score these responses based on their accuracy, relevance, and coherence. The feedback from the human experts serves as a reward signal that guides the RL algorithm in adjusting the model's parameters to improve future responses.

The human-in-the-loop process aids in capturing the subtleties of financial language and ensuring that the model's outputs meet professional standards. Financial experts can provide nuanced corrections and suggestions that are not easily captured through automated metrics alone.

By undergoing this fine-tuning process, the LLM becomes adept at processing and generating information that aligns with the expectations and requirements of financial professionals. The model's enhanced understanding of financial terminology, concepts, and document structures enables it to serve as a valuable tool for financial analysis, capable of assisting analysts in making informed decisions based on up-to-date and contextually relevant insights.

The innovations described herein represent a significant leap forward in the field of RAG-based systems, particularly in the realm of financial analysis. By integrating advanced techniques such as query augmentation, noise filtering, relevance ranking, prompt engineering, and fine-tuning of LLMs, the novel RAG system described herein offers a level of precision, personalization, and contextual awareness that far surpasses conventional RAG systems.

One innovation is the query augmentation component, which employs a knowledge graph to expand and enrich user queries with semantically related concepts. This not only broadens the scope of the search but also ensures that the retrieval process captures a comprehensive array of relevant documents. Coupled with noise filtering and relevance ranking, the system adeptly sifts through vast amounts of data to present the most pertinent information, thereby streamlining the decision-making process for financial professionals.

The prompt engineering and fine-tuning of LLMs are particularly transformative, tailoring the generative capabilities of the model to produce outputs that adhere to the specialized requirements of financial analysis. Unlike traditional RAG systems that may generate generic or less targeted responses, this approach ensures that the generated content is not only contextually relevant but also conforms to the specific informational needs and preferences of the user. The incorporation of reinforcement learning with human experts in the loop further refines the model's accuracy and reliability, imbuing it with a level of expertise that mirrors that of seasoned financial analysts.

### Machine and Software Architecture

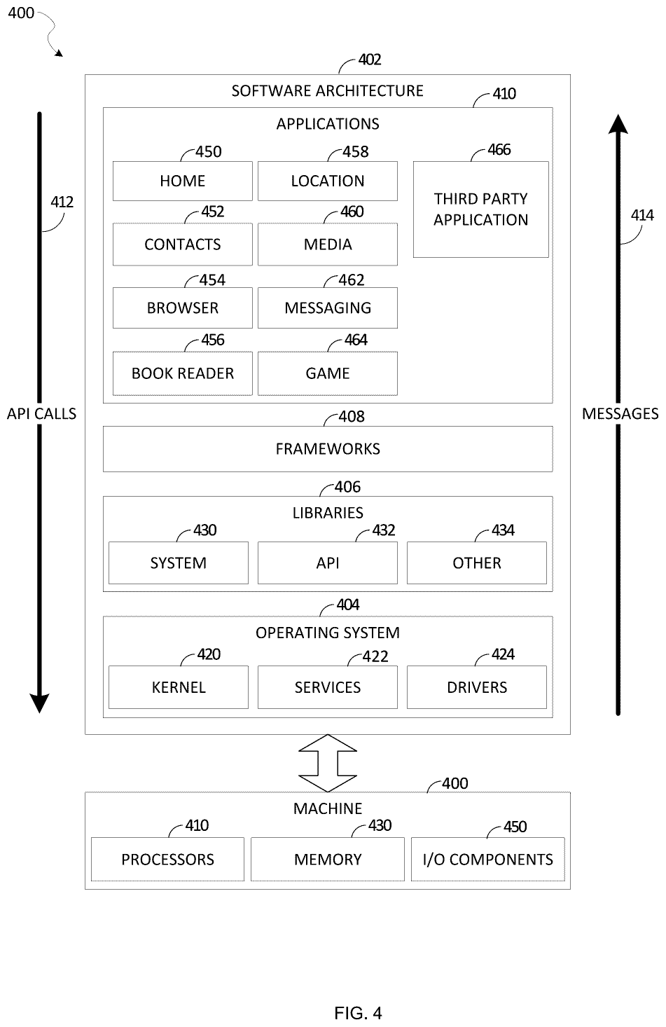

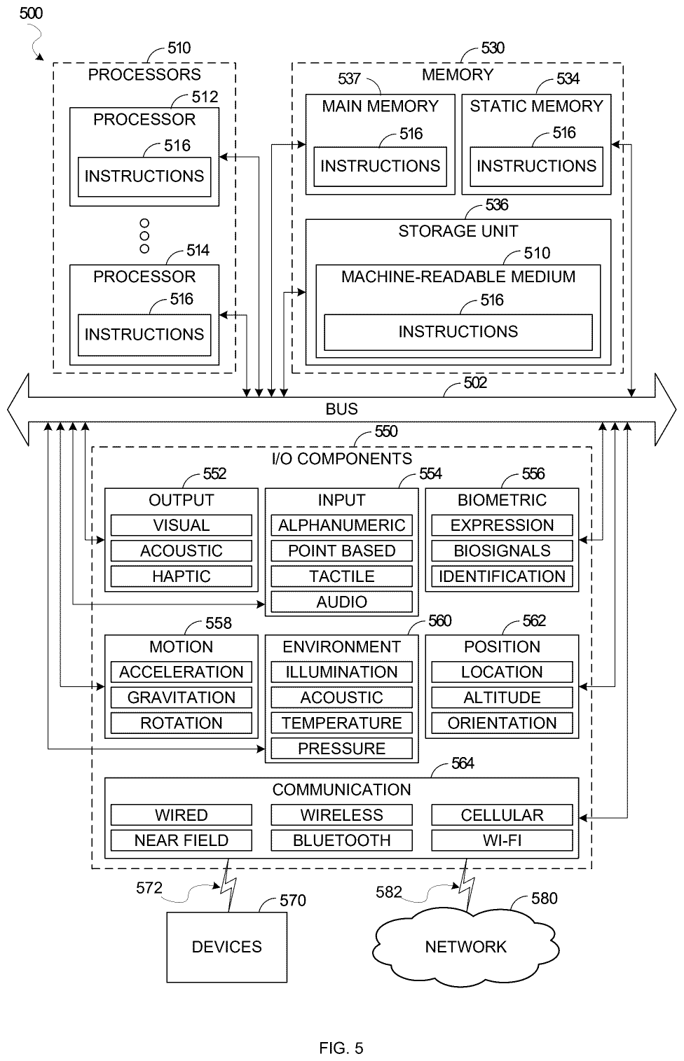

FIG. 4 is a block diagram 400 illustrating a software architecture 402, which can be installed on any of a variety of computing devices to perform methods consistent with those described herein. FIG. 4 is merely a non-limiting example of a software architecture, and it will be appreciated that many other architectures can be implemented to facilitate the functionality described herein. In various embodiments, the software architecture 402 is implemented by hardware such as a machine 500 of FIG. 5 that includes processors 510, memory 530, and input/output (I/O) components 550. In this example architecture, the software architecture 402 can be conceptualized as a stack of layers where each layer may provide a particular functionality. For example, the software architecture 402 includes layers such as an operating system 404, libraries 406, frameworks 408, and applications 410. Operationally, the applications 410 invoke API calls 412 through the software stack and receive messages 414 in response to the API calls 412, consistent with some embodiments.

In various implementations, the operating system 404 manages hardware resources and provides common services. The operating system 404 includes, for example, a kernel 420, services 422, and drivers 424. The kernel 420 acts as an abstraction layer between the hardware and the other software layers, consistent with some embodiments. For example, the kernel 420 provides memory management, processor management (e.g., scheduling), component management, networking, and security settings, among other functionality. The services 422 can provide other common services for the other software layers. The drivers 424 are responsible for controlling or interfacing with the underlying hardware, according to some embodiments. For instance, the drivers 424 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 406 provide a low-level common infrastructure utilized by the applications 410. The libraries 406 can include system libraries 430 (e.g., C standard library) that can provide functions such as memory allocation functions, string manipulation functions, mathematic functions, and the like. In addition, the libraries 406 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC). Adaptive Multi-Rate (AMR) audio codec. Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 406 can also include a wide variety of other libraries 434 to provide many other APIs to the applications 410.

The frameworks 408 provide a high-level common infrastructure that can be utilized by the applications 410, according to some embodiments. For example, the frameworks 408 provide various GUI functions, high-level resource management, high-level location services, and so forth. The frameworks 408 can provide a broad spectrum of other APIs that can be utilized by the applications 410, some of which may be specific to a particular operating system 404 or platform.

In an example embodiment, the applications 410 include a home application 450, a contacts application 452, a browser application 454, a book reader application 456, a location application 458, a media application 460, a messaging application 462, a game application 464, and a broad assortment of other applications, such as a third-party application 466. According to some embodiments, the applications 410 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 466 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 412 provided by the operating system 404 to facilitate functionality described herein.

FIG. 5 illustrates a diagrammatic representation of a machine 500 in the form of a computer system within which a set of instructions may be executed for causing the machine to perform any one or more of the methodologies discussed herein, according to an example embodiment. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. For example the instructions 516 may cause the machine 500 to execute any one of the methods or algorithmic techniques described herein. Additionally, or alternatively, the instructions 516 may implement any one of the systems described herein. The instructions 516 transform the general, non-programmed machine 500 into a particular machine 500 programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 416 to perform any one or more of the methodologies discussed herein.

The machine 500 may include processors 510, memory 530, and I/O components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 512 and a processor 514 that may execute the instructions 516. The term “processor” is intended to include multi-core processors that may comprise two or more independent processors (sometimes referred to as “cores”) that may execute instructions contemporaneously. Although FIG. 5 shows multiple processors 510, the machine 500 may include a single processor with a single core, a single processor with multiple cores (e.g., a multi-core processor), multiple processors with a single core, multiple processors with multiples cores, or any combination thereof.

The memory 530 may include a main memory 532, a static memory 534, and a storage unit 536, all accessible to the processors 510 such as via the bus 502. The main memory 530, the static memory 534, and storage unit 536 store the instructions 516 embodying any one or more of the methodologies or functions described herein. The instructions 516 may also reside, completely or partially, within the main memory 532, within the static memory 534, within the storage unit 536, within at least one of the processors 510 (e.g., within the processor's cache memory), or any suitable combination thereof, during execution thereof by the machine 500.

The I/O components 550 may include a wide variety of components to receive input, provide output, produce output, transmit information, exchange information, capture measurements, and so on. The specific 1/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion and the grouping is in no way limiting. In various example embodiments, the I/O components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 558 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 662 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a USB).

Moreover, the communication components 664 may detect identifiers or include components operable to detect identifiers. For example, the communication components 664 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix. Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 530, 532, 534, and/or memory of the processor(s) 510) and/or storage unit 536 may store one or more sets of instructions and data structures (e.g., software) embodying or utilized by any one or more of the methodologies or functions described herein. These instructions (e.g., the instructions 516), when executed by processor(s) 610, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 580 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 580 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., HTTP). Similarly, the instructions 516 may be transmitted or received using a transmission medium via the coupling 572 (e.g., a peer-to-peer coupling) to the devices 570. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 516 for execution by the machine 500, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” are intended to mean the same thing and may be used interchangeably in this disclosure. The terms are defined to include both machine-storage media and transmission media. Thus, the terms include both storage devices/media and carrier waves/modulated data signals.

What is claimed is:

1. A computer-implemented method for processing financial queries using retrieval-augmented generation, the method comprising:
receiving a query and contextual information from a user device;
augmenting the query using a knowledge graph to create an expanded query, wherein the knowledge graph comprises nodes representing financial entities and edges representing relationships between the financial entities;
retrieving a set of documents based on the expanded query;
filtering the set of documents using the contextual information to remove irrelevant documents;
ranking the filtered documents based on relevance to the contextual information;
generating a prompt comprising the ranked documents and the query; and
providing the prompt to a generative language model to generate a response to the query.

2. The method of claim 1, wherein the contextual information comprises at least one of:
a user role, historical search patterns, a task being performed by the user, and a user interface from which the query was initiated.

3. The method of claim 1, wherein augmenting the query using the knowledge graph comprises:
identifying entities in the query;
selecting a subset of nodes and relationships from the knowledge graph based on the identified entities; and
generating one or more expanded queries based on the selected subset of nodes and relationships.

4. The method of claim 1, wherein retrieving the set of documents comprises:
encoding the expanded query as one or more embeddings; and
performing a vector-to-vector comparison between the one or more embeddings and document embeddings stored in a vector database to identify relevant documents.

5. The method of claim 1, wherein filtering the set of documents comprises:
applying one or more pre-trained machine learning models to exclude content that does not align with current needs of a user based on the contextual information.

6. The method of claim 1, further comprising:
performing a deduplication process to identify and remove duplicate information present across multiple documents; and
performing a diversification process to ensure a broad spectrum of unique and relevant content is included in the filtered documents.

7. The method of claim 1, wherein ranking the filtered documents comprises:
constructing a user profile based on a role of a user within a financial sector;
applying a ranking algorithm to the filtered documents based on the user profile; and
assigning a relevance score to each document based on alignment with information needs of the user.

8. The method of claim 1, further comprising:
pre-processing documents prior to retrieval by:
analyzing the documents using one or more pre-trained machine learning models;
generating metadata for each document using the pre-trained machine learning models; and
encoding the documents into embeddings for storage in a vector database.

9. The method of claim 8, wherein the metadata comprises at least one of:
entity recognition data, topic classification, and sentiment analysis.

10. The method of claim 1, wherein the knowledge graph comprises nodes corresponding to at least one of:
companies, persons, industries, resources, and financial concepts, wherein edges between the nodes represent relationships between the entities.

11. The method of claim 1, wherein the generative language model is fine-tuned for financial analysis to ensure generated responses adhere to domain-specific requirements of financial data analysis.

12. The method of claim 1, further comprising:
integrating the knowledge graph with a graph database, wherein nodes of the knowledge graph are aligned with nodes of the graph database to streamline the retrieval process.

13. The method of claim 1, wherein the filtering of the set of documents comprises:
utilizing metadata tags generated by pre-trained machine learning models to selectively include or exclude documents based on their alignment with the contextual information.

14. The method of claim 1, further comprising:
providing citations or sources of information in the response generated by the generative language model to enable users to verify the accuracy of the response and establish an audit trail for compliance and due diligence purposes.

15. A system for processing financial queries using retrieval-augmented generation, the system comprising:
at least one processor; and
at least one memory storage device storing instructions thereon which, when executed by the at least one processor, cause the system to perform operations comprising:
receiving a query and contextual information from a user device;
augmenting the query using a knowledge graph to create an expanded query, wherein the knowledge graph comprises nodes representing financial entities and edges representing relationships between the financial entities;
retrieving a set of documents based on the expanded query;
filtering the set of documents using the contextual information to remove irrelevant documents;
ranking the filtered documents based on relevance to the contextual information;
generating a prompt comprising the ranked documents and the query; and
providing the prompt to a generative language model to generate a response to the query.

16. The system of claim 15, wherein the operations further comprise:
pre-processing documents prior to retrieval by:
analyzing the documents using one or more pre-trained machine learning models;
generating metadata for each document using the pre-trained machine learning models; and
encoding the documents into embeddings for storage in a vector database.

17. The system of claim 15, wherein augmenting the query using the knowledge graph comprises:
identifying entities in the query;
selecting a subset of nodes and relationships from the knowledge graph based on the identified entities and the contextual information; and
generating one or more expanded queries based on the selected subset of nodes and relationships.

18. The system of claim 15, wherein filtering the set of documents comprises:
performing a deduplication process to identify and remove duplicate information present across multiple documents; and
performing a diversification process to ensure a broad spectrum of unique and relevant content is included in the filtered documents.

19. The system of claim 15, wherein the operations further comprise:
integrating the knowledge graph with a graph database, wherein nodes of the knowledge graph are aligned with nodes of the graph database to streamline the retrieval process; and
providing citations or sources of information in the response generated by the generative language model to enable users to verify the accuracy of the response.

20. A non-transitory computer-readable storage medium storing instructions thereon which, when executed by at least one processor, cause a computing device to perform operations comprising:
receiving a query and contextual information from a user device;
augmenting the query using a knowledge graph to create an expanded query, wherein the knowledge graph comprises nodes representing financial entities and edges representing relationships between the financial entities;
retrieving a set of documents based on the expanded query;
filtering the set of documents using the contextual information to remove irrelevant documents;
ranking the filtered documents based on relevance to the contextual information;
generating a prompt comprising the ranked documents and the query; and
providing the prompt to a generative language model to generate a response to the query.
